(19) United States
(12) Patent Application Publication
(10) Pub. No.: US 2026/0134695 A1
(43) Pub. Date: May 14, 2026

(54) METHOD FOR PROCESSING VIDEO SIGNALS AND MOTOR VEHICLE

(71) Applicant: AUDI AG, Ingolstadt (DE)

(72) Inventor: Andreas Knerlein, Pfaffenhofen (DE)

(73) Assignee: AUDI AG, Ingolstadt (DE)

(21) Appl. No.: 19/384,410

(22) Filed: Nov. 10, 2025

(30) Foreign Application Priority Data
Nov. 11, 2024 (DE) 10 2024 132 908.4

(51) Int. Cl. G06V 20/56; G06F 3/01; G06T 3/40; G06T 5/20

(52) U.S. Cl. CPC G06V 20/56; G06F 3/016; G06T 3/40; G06T 5/20

(57) ABSTRACT

A method for processing video signals in a motorl vehicle includes mapping acceleration signals from an acceleration sensor of the motor vehicle that describe a current acceleration of the motor vehicle to a change factor, such that there is a positive or negative correlation between the acceleration signals and the change factor. A parameterizable filter is applied to video signals generated by at least one camera, which captures at least one part of an environment of the motor vehicle, and causes a shift and/or selection of pixels from still images originating from a video which is obtained from the video signals, wherein a strength of the filter, which affects the shift and/or selection of the pixels, correlates with the change factor. The edited video signals are output on at least one display apparatus of the motor vehicle.

### CROSS-REFERENCE TO RELATED APPLICATIONS

This application claims the priority benefit of German Patent Application No. 10 2024 132 908.4 filed on Nov. 11, 2024, which is incorporated by reference herein in its entirety.

### BACKGROUND

### 1. Field

An invention relates to a method for processing video signals and to a motor vehicle which is configured to carry out the method, according to described examples.

### 2. Description of the Related Art

A motor vehicle may comprise at least one display apparatus. The display apparatus may be, for example, a display, a monitor, a transparent display applied, for example, to a window of the motor vehicle, a head-up display, a projection onto an interior surface of the motor vehicle, virtual reality (VR) glasses and/or augmented reality (AR) glasses.

Image contents can be displayed to an occupant by the display apparatus; for example, an environment of the motor vehicle can be output. The environment of the motor vehicle may be a predefinable area around the motor vehicle.

In order to display an environment of the motor vehicle on the display apparatus, provision may be made for the video signals to be generated by at least one camera of a motor vehicle, wherein the at least one camera captures at least one part of an environment of the motor vehicle, the generated video signals are edited by a computing unit and the edited video signals are output on at least one display apparatus of the motor vehicle. This means that the motor vehicle comprises at least one camera, wherein the at least one camera may be directed away from the motor vehicle, with the result that a capture area of the camera comprises a part of the environment of the motor vehicle. Each of the cameras can capture video signals in each case, wherein the video signals from the at least one camera can be combined to form a video. The video can be played back using the display apparatus.

A document (DE 10 2018 132 926 A1) from the prior art discloses determining display data for the dynamic virtual display in an automated driving mode, taking into account an actual acceleration of the vehicle. The disadvantage of this document is use of data from a virtual world that is displayed, thereby reducing the reference to reality. This reduces the advantage of better and/or intuitive perception of the acceleration.

### SUMMARY

An example object of the invention according to described examples may be to allow an occupant of the motor vehicle to intuitively perceive a current driving situation of the motor vehicle.

The example object may be achieved by the subject matter of the independent patent claims. Advantageous developments of the invention according to the examples are also described by the dependent patent claims, the following description and the figures.

As a solution, the invention according to the examples comprises a method for processing video signals. The processing of the video signals involves acceleration signals from an acceleration sensor of the motor vehicle that describe a current acceleration of the motor vehicle being mapped to a change factor. This means, for example, that the motor vehicle comprises at least one acceleration sensor that can be used to determine the current acceleration of the motor vehicle according to a method known from the prior art and to signal acceleration signals. The acceleration signals can be received and/or processed by another component of the motor vehicle, for example by a control unit and/or a computing unit.

According to the examples of the invention, provision is made for the acceleration signals to be mapped to the change factor. This may be carried out in a computing unit which is included in the motor vehicle. The mapping of the acceleration signals to the change factor means in particular that the change factor depends on the acceleration signals and thus on the current acceleration of the motor vehicle. In particular, the change factor is a function or the result of such a function into which the acceleration signals and thus the current acceleration flow as a function value and/or parameter. A modification of the current acceleration can cause a modification of the acceleration signals and thus a modification of the change factor. This means, in particular, that the change factor has a different value for a first current acceleration than for a second current acceleration if the values of the first current acceleration and of the second current acceleration differ from each other.

There is a positive or negative correlation between the acceleration signals and the change factor. In particular, there is a positive or negative correlation between the current acceleration of the motor vehicle and the change factor.

The terms positive and negative correlation are a statistical measure known from the prior art and describe how a first value of a first variable and a second value of a second variable behave with respect to each other. In the example of the invention, the acceleration signals and/or the current acceleration can be specified as the first variable and the change factor can be specified as the second variable. In the case of a positive correlation between the first and the second variable, the first value is larger, the larger the second value, and/or the second value is larger, the larger the first value. In addition, the first value is smaller, the smaller the second value, and/or the second value is smaller, the smaller the first value. In the case of a negative correlation between the first and the second variable, the first value is larger, the smaller the second value, and/or the second value is larger, the smaller the first value. In addition, the first value is smaller, the larger the second value, and/or the second value is smaller, the larger the first value.

Provision may therefore be made for the change factor to increase or decreases, in particular continuously or gradually, with a higher current acceleration.

A programmable filter is applied to the video signals generated by the at least one camera and causes a shift and/or selection of pixels from still images originating from the video which is obtained from the video signals. This means in particular that the video signals from each camera are each processed altogether to form a video which comprises the video signals from all the cameras considered and/or is composed of the video signals from all of the cameras.

Provision may be made for the parameterizable filter to be applied to the video. The parameterizable filter causes in particular processing and/or editing of at least some of the still images and/or frames of the video, wherein the editing and/or processing can involve individual pixels of the respective frame and/or still image being selected and/or shifted. This means that, by applying the parameterizable filter, an edited video is created from the video and is described by the edited video signals. The edited video may correspond to the video in which pixels were shifted and/or selected and combined to form the edited video. Provision may be made for not only one parameterizable filter but a plurality of parameterizable filters to be applied to the video and in particular for the edited video to be created only after the plurality of parameterizable filters have been applied. For example, a plurality of different filters described in the examples of the invention can be applied, for example successively or simultaneously, to the video, in particular in order to generate the edited video.

A strength of the filter, which affects the degree or extent to which the pixels are shifted and/or selected, correlates with the change factor. This means that the shift and/or selection of the pixels carried out by the filter may be dependent on the change factor and/or correlates with the change factor. The correlation of the strength of the filter with the change factor can be a positive or negative correlation. Additionally or alternatively, the strength of the filter may be given by the change factor and/or equal to the change factor.

According to the examples of the invention, the video signals edited with the filter are output. The output may be carried out by the already mentioned display apparatus of the motor vehicle, in particular by a display apparatus within the motor vehicle.

The advantage of the invention according to the examples is that an occupant of the motor vehicle can visually perceive the acceleration of the motor vehicle in an intuitive manner. In particular, the advantage of the examples of the invention is that image contents, in particular the video, can be presented in a manner that takes into account the physical conditions of human perception and/or the recording of information and can be directed to actually enabling and/or improving the perception of the information shown in a certain way and/or making it practical.

In the examples of the present invention, the information shown on the current acceleration of the motor vehicle can be made possible and/or improved for an occupant of the motor vehicle by processing the video signals. In the motor vehicle, for example, a driver and/or the at least one occupant can be shielded from the environment in such a way that in particular a driving experience that is as comfortable as possible can be made possible. However, this means that a sense of the current acceleration of the motor vehicle and/or perception of the current acceleration of the motor vehicle, in particular by the at least one occupant and/or by the driver, is lost, in particular since forces acting on the basis of the current acceleration are shielded and/or attenuated by the shielding of the motor vehicle from the environment. The perception of the information shown, that is to say the current acceleration of the motor vehicle, can be made possible and/or improved by the described visual display of the acceleration, which takes place by processing the video signals in a manner according to the invention. This enables the user and/or occupant of the motor vehicle to quickly and/or efficiently and/or intuitively understand the transmitted information, i.e. the current acceleration of the motor vehicle. A presentation of video contents that takes account of the physical conditions of human perception, in particular visual perception for grasping information, is therefore effected such that this capture, in particular the visual capture, of the video can enable and/or improve the perception of the current acceleration by the person and/or by the at least one occupant of the motor vehicle.

In order to create the video, for example, the method of stitching images that is known from the prior art, in particular from photography, can be applied to the video signals and/or individual videos from the individual cameras. For example, the stitching can be applied to the individual frames and/or still images of the video signals and/or individual videos from the individual cameras. Additionally or alternatively, the video signals and/or individual videos from all cameras can be combined to form a video by virtue of the fact that relative orientations of the cameras with respect to each other are known and the images and/or individual videos from the cameras are combined to form the one single video based on the relative orientations of the cameras with respect to each other according to a method from the prior art, with the result that, in particular, the area shown in the video corresponds to the capture area of all cameras together. Additionally or alternatively, objects in the individual videos from the cameras can be recognized by object recognition, and the same objects occurring in a plurality of individual videos can be overlapped, such that the individual videos can be combined to form the video. This method is also known from the prior art.

The invention according to the examples also comprises developments that result in additional advantages.

One development comprises the fact that speed signals from at least one speed sensor that describe a current speed of the motor vehicle are additionally mapped to the change factor. This means that, in addition to the acceleration signals, the change factor also depends on the speed signals and/or the change factor correlates with the acceleration signals and the speed signals. The speed signals can be provided by at least one speed sensor, wherein the at least one speed sensor may be included in the motor vehicle in a known manner. The at least one speed sensor can be used to determine a current speed of the motor vehicle, for example by a method known from the prior art for determining a speed, in particular the current speed, of the motor vehicle. The current speed of the motor vehicle may be included in the speed signals and/or the speed signals may describe the current speed of the motor vehicle.

In the case of a positive correlation between the acceleration signals and the change factor, there is also a positive correlation between the speed signals and the change factor and, in the case of a negative correlation between the acceleration signals and the change factor, there is also a negative correlation between the speed signals and the change factor. In particular, this means that the correlation between the speed signals and the change factor is equal to the correlation between the acceleration signals and the change factor. In particular, this means that the change factor is greater and/or smaller if the current speed, just like the current acceleration, is greater. Additionally or alternatively, it may mean that the change factor is greater and/or smaller if the current speed, just like the current acceleration, is smaller. Both a modification of the current speed and a modification of the current acceleration can change and/or influence the change factor, in which case an increase in the current acceleration can change the change factor in the same way and/or in the same direction (increase and/or decrease), but not necessarily by the same amount, as an increase in the current speed, and a decrease in the current acceleration can change the change factor in the same way and/or in the same direction (increase and/or decrease), but not necessarily by the same amount, as a decrease in the current speed. There may be a positive correlation between the acceleration signals and the current acceleration. There may be a positive correlation between the speed signals and the speed.

The advantage of the example is that both a current acceleration and a current speed can be intuitively displayed for and/or perceived by an occupant of the motor vehicle. In particular, this makes it possible both to perceive the current acceleration and to perceive the current speed. Advantageously, the invention according to the examples makes it possible to intuitively communicate to an occupant of the motor vehicle and/or makes it possible for an occupant of the motor vehicle to perceive when a high and/or a critical speed and/or a current speed is reached, which in particular exceeds a predefinable reference speed, and/or when a predefinable reference speed can be reached due to a current acceleration, for example, within a predefinable time interval. In other words, a criticality (e.g. a risk of skidding and/or slipping and/or a risk of oversteering and/or understeering) can be signaled in the video contents. This allows a warning, for example of an excessively high speed and/or acceleration, to be output in an intuitive and quickly graspable and/or perceptible manner.

One example comprises the fact that the filter causes a shift of an image section from the video, wherein the image section is output on the display apparatus, and wherein the strength of the filter is given by a speed and/or acceleration of the shift of the image section. This may include the fact that a capture area of the at least one camera is larger than an area that is displayed and/or output on the display apparatus; for example, only one image section of the video can be output on the display apparatus. An image section of a video can be understood as meaning the fact that an image section is respectively cut out from each frame and/or at least some of the frames, and only this image section is displayed in each case and/or the image sections of the frames and/or still images form the video. The filter can cause the image section output on the display apparatus to be changed and/or shifted. A position of the image section in the video and/or in the capture area of the at least one camera and/or of the video can be changed by the filter. The speed of the change and/or shift and/or the acceleration of the change and/or shift of the image section is/are given by the strength of the filter, which may correlate with the change factor. This means that a higher change factor can cause a faster and/or slower shift of the image section in the video and/or a lower change factor can cause a faster and/or slower shift of the image section in the video. Provision may be made for only a portion of the video to be output on the display apparatus, wherein it may refer to a spatial portion, and wherein a modification, in particular a speed and/or acceleration of the modification, of a selection of the portion and/or image section output on the display apparatus can be influenced by the filter.

The advantage of the example is that an accelerated movement of the motor vehicle can be displayed in a simple manner and/or a movement of the motor vehicle, the acceleration and/or speed of which is/are greater than the current acceleration and/or speed, can be displayed. For this purpose, the image section can be pivoted and/or shifted from one end of the capture area of the at least one camera and/or of the video to another end of the capture area of the at least one camera and/or of the video, in particular to an opposite end of the capture area of the at least one camera and/or of the video. Additionally or alternatively, the image section can be pivoted and/or shifted along a section that is a part of a path that runs from one end of the capture area of the at least one camera and/or of the video to another end of the capture area of the at least one camera and/or of the video, in particular to an opposite end of the capture area of the at least one camera and/or of the video. In particular, a speed and/or acceleration greater than the current speed and/or acceleration can be displayed by moving the image section within the entire capture area of the at least one camera and/or of the video, wherein only the image section and in particular only a partial area and/or partial section of the video is displayed on the at least one display apparatus, which allows the at least one occupant to perceive a higher speed and/or acceleration than the current speed and/or the current acceleration.

One example comprises the fact that a model of the environment, which changes over time, is determined from the video signals from the plurality of cameras and simulates the environment mapped to the video signals from a plurality of perspectives. This means, in particular, that the motor vehicle comprises a plurality of cameras that perceive the environment from different angles and/or perspectives in each case. This means that the cameras have angles relative to each other that are not equal to zero, with the result that the different cameras capture the environment from different viewing angles and/or angles and/or perspectives. A model, in particular a three-dimensional model, can be determined by capturing at least one object and/or the environment from different perspectives. This can be carried out, for example, by a method known from the prior art. The model can describe the object and/or the environment from the different perspectives and/or from additional perspectives that lie between the perspectives of the various cameras.

According to the example, the filter changes the perspective of the model. This may mean that an image of the model of the environment is displayed and/or output on the display apparatus from one perspective and the application of the filter modifies the image of the model of the environment displayed on the display apparatus in such a way that the image displayed on the display apparatus after applying the filter shows and/or displays the environment and/or the model of the environment from a different perspective. The strength of the filter is given by a speed and/or an acceleration of the change (modification) of perspective. Provision may be made for a modification and/or change of the perspective, from which the image of the environment displayed on the display apparatus shows the model of the environment and/or the environment, to be influenced by the strength of the filter.

The output comprises rendering the environment from the model in the changed perspective. In particular, rendering can create and/or generate the image that represents and/or reproduces the environment based on the model and/or the model of the environment.

The advantage of the example is that an acceleration and/or a speed of the motor vehicle which is/are greater than the current speed and/or the current acceleration of the motor vehicle can be displayed on the display apparatus by modifying the display of the perspective.

One example comprises the fact that the video signals describe an environment in the direction of travel of the motor vehicle. This means that the at least one camera has a capture area that lies in the direction of travel of the motor vehicle and/or in front of the motor vehicle. If the capture area of the at least one camera is greater than an area of an environment in the direction of travel of the motor vehicle, those video signals whose capture area comprises a part of an environment in the direction of travel of the motor vehicle and/or the environment in the direction of travel of the motor vehicle may be selected from the video signals. Additionally or alternatively, a preliminary video may be created from the video signals, from which the video is limited by restricting the area depicted in the video to that area of the environment which is and/or is arranged in the direction of travel of the motor vehicle, as seen from the motor vehicle. In particular, according to the development, a video of the environment in the direction of travel of the motor vehicle can be provided.

The filter causes zooming into the video. Zooming in may mean that an ever smaller area and/or image section of the video is displayed so as to be increasingly larger, such that the ever smaller area and/or image section of the video is still presented and/or displayed on an entire display surface of the display apparatus and/or by means of the entire display apparatus. Additionally or alternatively, zooming in may mean enlarging a field of view and/or an image section of the video. Zooming in makes it possible to display more detail and/or zooming in makes it possible shift a viewing focus from an overview to specific features and/or objects in the video.

The strength of the filter is given by a speed and/or an acceleration of the zooming into the video. This may mean that the speed and/or acceleration at which an image section of the video becomes ever smaller and is displayed so as to be increasingly larger, in particular, depend(s) on the strength of the filter.

The advantage of the example is that a speed and/or acceleration can be displayed in a simple manner by an environment which is in the direction of travel of the motor vehicle, as a result of which the method is particularly well suited to at least one display apparatus which is in the direction of travel relative to at least one occupant.

One example comprises the fact that the filter additionally causes a distortion of the video along lines which extend from a center point of the video, which can be displayed and/or is arranged centrally on the display apparatus, to an edge of the video. This means that the video has a center point, wherein the center point can be given by the fact that, when the video and/or an image section of the video is/are output on the display apparatus, the center point is arranged centrally and/or in the middle of the display apparatus. The filter can cause a distortion of the video along lines which extend from the center point of the video to the edge of the video, wherein a strength of the distortion of the video can increase, the further away one moves from the center point along at least one of the lines. The distortion can produce an image as would be recorded by a camera having a lens defect of a cushion-shaped distortion known from the prior art.

The strength of the filter is given by a speed and/or acceleration at which the distortion is modified. Additionally or alternatively, the strength of the filter may indicate a strength of the distortion.

The advantage of the example is that a speed and/or acceleration of the motor vehicle, in particular a speed and/or acceleration that may be greater and/or less than the current speed and/or the current acceleration of the motor vehicle, can be displayed and/or perceived by an occupant in a particularly simple and/or effective and/or intuitive manner.

One example comprises the fact that the edited video signals are output in the background on the at least one display apparatus and an artificial horizon is simulated in the foreground, the inclination of which correlates with a lateral acceleration during cornering. In other words, it is possible to determine how great the lateral acceleration is during cornering of the motor vehicle and, depending on the amount and/or direction of lateral acceleration, an inclination of the artificial horizon can be set. The artificial horizon can be an artificial horizon known from the prior art, that is to say in particular a line that can change its inclination relative to a horizontal line. According to the example, the change in inclination may correlate with the lateral acceleration of cornering and/or may depend on the lateral acceleration during cornering.

The advantage of the example is that not only a longitudinal acceleration can be intuitively perceived by an occupant of the motor vehicle, but also a lateral acceleration can be displayed, by which the at least one occupant of the motor vehicle can perceive the lateral acceleration in an intuitive and/or simplified manner. This can reduce the kinetosis for a viewer.

According to one example, real-time processing of the video signals is carried out by the filter, in which case real-time processing of the video can be understood as meaning the fact that the video is processed and/or edited without time delays and/or delays, in particular with respect to the recording. The advantage of the real-time processing is that the environment, which can be perceived by the at least one occupant of the motor vehicle by looking from a window of the motor vehicle, can also be displayed and/or output on the display apparatus in processed and/or edited form, as a result of which the perception of the speed and/or acceleration, which is effected by editing and/or processing the video signals, is more realistic and/or more authentic and/or stronger. The speed and/or acceleration intended to be perceived by the occupant by editing and/or processing the video signals can be displayed and/or communicated more intuitively and/or better and/or more effectively through the real-time processing.

One example, which has the advantage that an acceleration effect caused by the application of the filter and used to simulate an acceleration higher than the current acceleration is additionally enhanced, comprises at least one of the following features.
a. Sound effects, in particular a turbine sound, are output in the motor vehicle, wherein the volume and/or pitch of said sound effects correlate(s) with the change factor. This means, in particular, that sounds and/or auditory contents are output in the motor vehicle. In particular, a turbine sound can be played back in the motor vehicle as a sound effect and/or auditory content, wherein, depending on the value of the change factor and/or depending on the change factor, a turbine sound can be selected for a predefinable number of revolutions per minute.
b. Additionally or alternatively, a simulation of at least one component of a way of transport can be simulated at a way of transport acceleration (a current acceleration of the way of transport) and/or a way of transport speed (a current speed of the way of transport) on a simulation display apparatus in the motor vehicle, wherein the way of transport acceleration and/or the way of transport speed correlate(s) with the change factor. In particular, it is possible to select a way of transport, the maximum speed and/or maximum acceleration of which is/are greater than a maximum speed and/or current speed and/or maximum acceleration and/or current acceleration of the motor vehicle. For example, an aircraft can be selected as the way of transport. At least one component part of the way of transport and/or at least one component of the way of transport, which may have different optical properties and/or different appearances at different speeds and/or at different accelerations, can be simulated for different speeds and/or accelerations, wherein, depending on the change factor and/or on the basis of the change factor, at least one of the simulations can be selected and/or played back on the simulation display apparatus in the motor vehicle.
c. Additionally or alternatively, during cornering of the motor vehicle, a vehicle structure of the motor vehicle may be higher on the side of a bend than on the inside of a bend by adjusting a suspension. A prerequisite for this may be the fact that the motor vehicle has an air suspension that can be used to adjust a height and/or a spring travel of the suspension. Provision may be made for a lateral acceleration of the motor vehicle to be determined during cornering and, depending on the value of the lateral acceleration, for the suspension to be adjusted such that one vehicle side, in particular a vehicle side on the outside a bend, is arranged so as to be higher and/or has a greater spring travel than another side of the motor vehicle, in particular a side of the motor vehicle located on the inside of a bend. One side of the motor vehicle may be arranged so as to be higher than another side of the motor vehicle by setting a greater spring travel on the higher side of the motor vehicle and/or by setting another preload. Additionally or alternatively, the bellows on the side on which the motor vehicle is lower may be at least partially emptied in order to create the effect that the motor vehicle is lower on that side. A difference in height between the two sides of the vehicle due to the suspension being adjusted can depend on the amount of lateral acceleration and/or can correlate with the amount of lateral acceleration, in particular can positively correlate.
d. Additionally or alternatively, haptic feedback, in particular vibrations and/or movements of at least one vehicle seat, can be provided and correlates with the change factor. This means, in particular, that a driver and/or at least one occupant of the motor vehicle receive(s) haptic feedback, the strength of which depends on the change factor.

One example comprises the fact that the video signals are stored and are output at a slower speed on the at least one display apparatus and, at a current acceleration which exceeds a predefinable acceleration threshold value, an accelerated playback of the edited video signals takes place on the at least one display apparatus in addition to the application of the filter. This means, in particular, that the motor vehicle comprises at least one buffer in which the video signals and/or the edited video and/or edited video signals is/are buffered. The video signals and/or the edited video and/or edited video signals can be retrieved from the buffer, such that, for example, an output can be effected on the display apparatus. In particular, the video signals and/or the edited video and/or the edited video signals is/are not displayed in real time, and so video signals and/or the edited video and/or edited video signals is/are stored in the buffer, but has/have not yet been played back. This means that video signals and/or edited videos and/or edited video signals that have already been recorded but not yet played and/or played back may be stored in the buffer. This can be achieved by playing back the video signals and/or edited videos and/or edited video signals at a playback speed that is less than real-time playback and/or a recording speed. In particular, the video signals are played back more slowly than they were recorded.

At a current acceleration that exceeds a predefinable acceleration threshold value, in addition to the application of the filter, an accelerated playback of the video signals and/or the edited videos and/or the edited video signals takes place. This means, in particular, that video signals and/or edited videos and/or edited video signals are retrieved from the buffer, and are output and/or played back on the at least one display apparatus, wherein the playback can be carried out at a playback speed greater than the slowed-down playback speed and/or the recording speed.

This results in the advantage that an accelerated and/or faster movement of the motor vehicle can be represented by the video played back and/or can be perceived by the at least one occupant in a simple and uncomplicated manner.

For applications or application situations which may arise for the method and are not explicitly described here, there can be provision for the method to involve an error message and/or a request to input user feedback being output and/or a default setting and/or a predetermined initial state being set.

The invention according the examples also includes the computing unit for the motor vehicle, which edits the video signals. The computing unit can comprise a data processing apparatus or a processor device (processor circuit) configured to carry out the method according to the examples of the invention. For this purpose, the processor device can have at least one microprocessor and/or at least one microcontroller and/or at least one FPGA (field-programmable gate array) and/or at least one DSP (digital signal processor). In particular, a CPU (central processing unit), a GPU (graphical processing unit) or an NPU (neural processing unit) can each be used as the microprocessor. In addition, the processor device can have program code configured so as, when executed by the processor device, to carry out the method according to the examples of the invention. The program code may be stored in a data memory of the processor device. The processor device can be based e.g. on at least one circuit board and/or on at least one SoC (system on chip).

The invention according to the examples comprises a motor vehicle comprising at least one display apparatus, at least one camera and an acceleration sensor, wherein the motor vehicle is configured to carry out a method according to the examples of the invention.

The invention according to the examples also includes developments of the motor vehicle according to the examples of the invention which have features as have already been described in connection with the developments of the method according to the examples of the invention. For this reason, the corresponding developments of the motor vehicle according to the examples of the invention are not described again here.

The motor vehicle according to the examples of the invention may be in the form of a motor car, in particular a passenger car or truck, or in the form of a minibus or motorcycle.

As a further solution, the invention according to the examples also comprises a computer-readable storage medium comprising program code which, when executed by a computer or a computer network, causes the computer or the computer network to carry out the method according to the examples of the invention. The storage medium may be provided at least partially as a non-volatile data memory (for example as a flash memory and/or as an SSD solid state drive) and/or at least partially as a volatile data memory (for example as a RAM-random access memory). The storage medium may be arranged in the computer or computer network. However, the storage medium may also be operated, for example, as what is known as an app store server and/or cloud server on the Internet. The computer or computer network can be used to provide a processor circuit with, for example, at least one microprocessor. The program code may be provided as binary code and/or as assembler code and/or as source code of a programming language (for example C) and/or as a program script (for example Python). The computer-readable storage medium can alternatively be realized by a signal with computer-readable data, e.g. a time-varying voltage signal and/or a radio signal.

The invention also comprises the combinations of the features of the described examples. The invention thus also comprises implementations that each have a combination of the features of several of the described examples, unless the examples have been described as being mutually exclusive.

The example object may be achieved by the subject matter of the independent patent claims. Advantageous developments of the invention according to the examples are also described by the dependent patent claims, the following description and the figure(s).

### BRIEF DESCRIPTION OF DRAWINGS

Examples of the invention are described below. In this regard:

FIG. 1 shows a motor vehicle according to an example of the invention;

FIG. 2 shows a filter according to an example of the invention;

FIG. 3 shows a filter according to another example of the invention;

FIG. 4 shows a filter according to another example of the invention;

FIG. 5 shows a filter according to another example of the invention;

FIG. 6 shows a filter according to another example of the invention.

### DESCRIPTION

The examples explained below are examples of the invention. In the examples, the described components of the examples each represent individual features of the examples of the invention that should be considered independently of one another and that each also develop the examples of the invention independently of one another. The disclosure is therefore also intended to comprise combinations of the features of the examples other than those illustrated. In addition, the described examples can also be supplemented by further features of the examples of the invention that have already been described.

In the figures, identical reference signs denote functionally identical elements in each case.

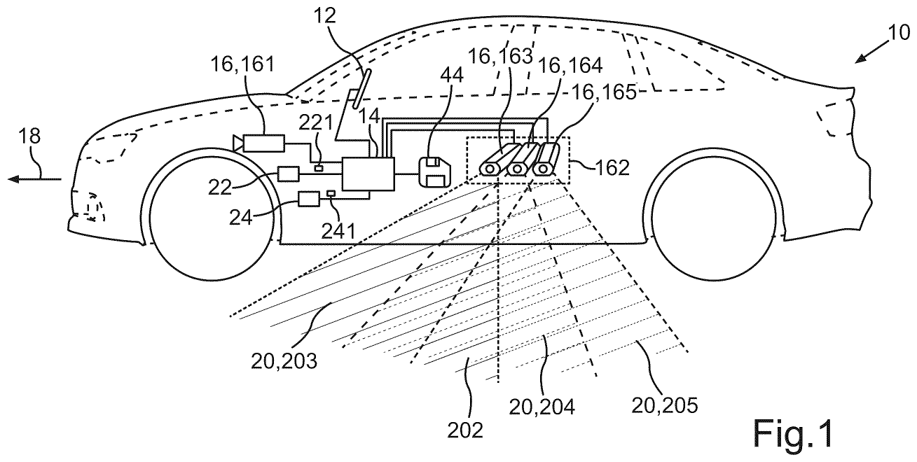

FIG. 1 shows a motor vehicle 10 by way of example. The motor vehicle 10 comprises at least one display apparatus 12, at least one computing unit 14 and at least one camera 16, each camera 16 providing video signals in each case. By way of example, FIG. 1 shows at least one single camera 161 having a viewing direction, wherein, by way of example in FIG. 1, a direction of travel 18 of the motor vehicle 10 is given as the viewing direction. In addition or as an alternative to the at least one single camera 161, the motor vehicle 10 may comprise at least one camera system 162 comprising a plurality of cameras 16 (the cameras 163, 164 and 165 in the example in FIG. 1). The plurality of cameras 16 of the camera system 162 may be configured to capture an environment of the motor vehicle 10 from a plurality of different perspectives. For this purpose, the plurality of cameras 16 may each have different angles and/or different viewing directions with respect to each other. In FIG. 1, this is indicated by way of example by the fact that the lenses of the plurality of cameras 16 each look in different directions. This can result in different capture areas 20 for the various cameras 16. For example, camera 163 has the capture area 203, camera 164 has the capture area 204 and camera 165 has the capture area 205. In particular, the capture areas 20 of the cameras can overlap, and so there is a capture area 202 common to the cameras 16 of the camera system 162 and/or a capture area common to the plurality of cameras 16, in which the environment and/or a part of the environment of the motor vehicle 10 is/are captured from a plurality of different perspectives. This means that an environment and/or a part of the environment in the common capture area 202 of the plurality of cameras 16 is/are captured from a plurality of different perspectives and/or viewing angles.

In addition, the motor vehicle 10 comprises at least one acceleration sensor 22. The acceleration sensor 22 is configured to determine a current acceleration of the motor vehicle 10, which can describe the acceleration with which the motor vehicle 10 accelerates at a current time. The acceleration sensor 22 is configured in particular to transmit the current acceleration of the motor vehicle 10 to the computing unit 14 using acceleration signals 221. In addition, the motor vehicle 10 may comprise at least one speed sensor 24 which determines a current speed of the motor vehicle 10. The current speed of the motor vehicle 10 can be transmitted to the computing unit 14 as speed signals 241.

The acceleration signals 221 and/or the speed signals 241, and thus the current acceleration and/or the current speed of the motor vehicle 10, can be mapped to a change factor. This means, in particular, that a change factor which is dependent on the value of the current acceleration and/or current speed of the motor vehicle 10 is formed. In particular, provision may be made for the change factor to increase and/or decrease with increasing current acceleration and/or increasing current speed and to decrease or increase with decreasing current acceleration and/or current speed. There may thus be a positive or negative correlation between the change factor and the current acceleration and/or current speed. In the case of a positive correlation between the change factor and the current acceleration, there may be a positive correlation between the change factor and the current speed, and, in the case of a negative correlation between the change factor and the current acceleration, there may be a negative correlation between the change factor and the current speed.

A parameterizable filter is applied to the video signals from the at least one camera 16 which have been transmitted, for example, to the computing unit 14 by the at least one camera 16, wherein the strength of the filter correlates with the change factor. The filter may affect a selection and/or shift of pixels in a video created from the video signals from the at least one camera 16, wherein the shift and/or selection of the pixels may be dependent on the amplification factor. The filter can be applied, that is to say the video signals and/or the video can be edited, in real time. In particular, there is real-time processing of the video signals.

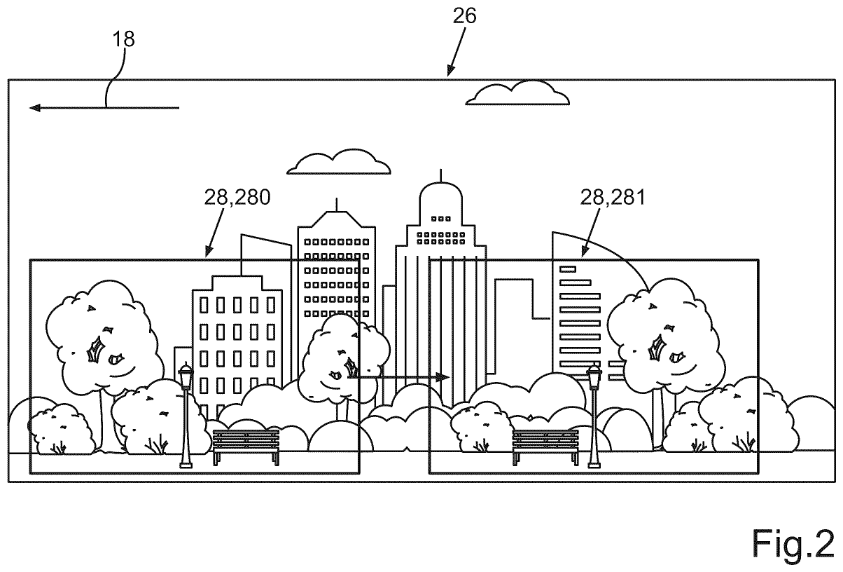

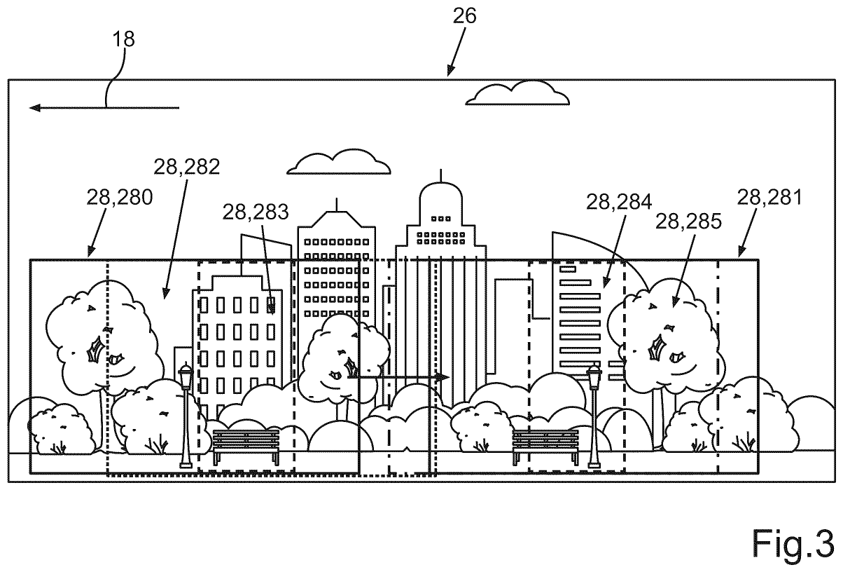

For example, the filter can cause an image section 28 of the video output on the display apparatus 12 to be shifted. This is shown by way of example in FIG. 2 and FIG. 3. These each show by way of example an environment 26 as captured by one or more cameras 16. For example, it may be the capture area of a camera 16, for example a single camera 161.

Additionally or alternatively, it may be a combined capture area which can result from joining and/or combining the capture areas of a plurality of cameras 16, for example a plurality of cameras 163, 164, 165 of a camera system 162. This means, in particular, that the images from a plurality of cameras 16 are joined to form one image, for example by stitching, in which case this can be carried out for each frame.

An image section 28 can be selected from the environment 26 captured by the at least one camera 16 and is output via the display apparatus 12. This means, in particular, that only the image section 28, rather than the environment 26 captured by the at least one camera 16, is output and/or displayed on the display apparatus 12. The image section 28 can have a predefinable position relative to the capture area of the at least one camera 16. By way of example, in FIG. 2 and FIG. 3, the image section 28 is arranged at that edge of the capture area and/or the environment 26 which is in the direction of travel 18. The position of the image section 28 is in particular independent of the objects in the environment 26, as a result of which in particular the position of the image section 28 relative to the capture area of the at least one camera 16 does not change over time. That part of the environment 26 which is within the image section 28 and is displayed on the display apparatus 12 may change over time, for example due to a movement of the motor vehicle 10.

By applying the filter, provision may be made for the image section 28 to be shifted, in particular relative to the capture area of the at least one camera 16, such that, instead of the image section 280, a new image section 281 is displayed, the position of which relative to the capture area differs from the position of the image section 280. An application of the filter can modify the position of the image section 28 relative to the capture area, in which case it may be a continuous shift of the image section 28, as shown schematically by FIG. 3. This means, in particular, that no abrupt transition takes place between the image section 280 and the new image section 281, but rather intermediate image sections 282 to 285, whose position relative to the capture area is between the position of the image section 280 before shifting and the position of the new image section 281 after shifting, are displayed on the display apparatus 12 during shifting. In an example, the image section 28 is shifted counter to the direction of travel 18, as also illustrated by way of example in FIG. 2 and FIG. 3. A speed and/or acceleration of shifting may be given by the strength of the filter, which correlates with the amplification factor.

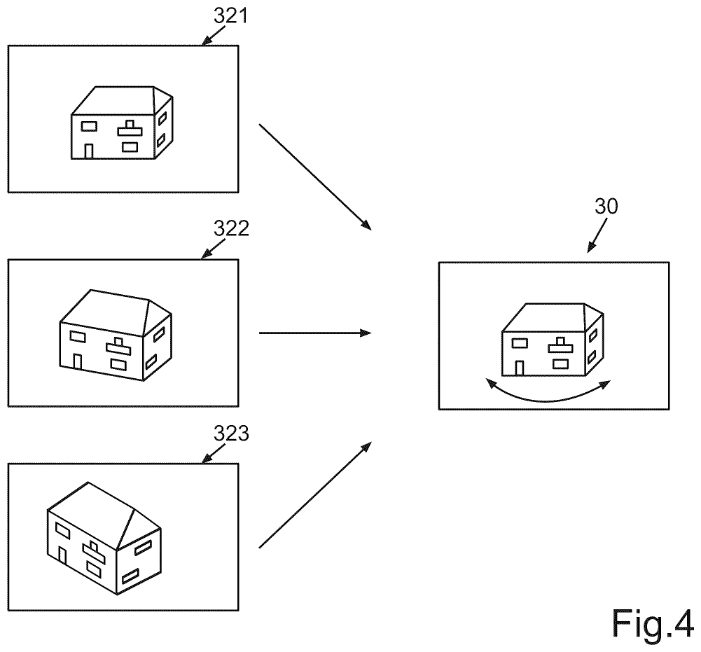

Additionally or alternatively, the filter can modify a perspective of a model 30 of a part of the environment 26 that has been captured by a plurality of cameras 16 from different perspectives. This is shown by way of example in FIG. 4. A plurality of cameras 16 can each have angles with respect to each other that are not equal to zero, with the result that the cameras 16 can each capture a part of the environment 26 from different viewing angles and/or perspectives. That part of the environment 26 which is in a common capture area 202 of a plurality of cameras 16 can be perceived from a plurality of perspectives by the plurality of cameras 16 which can have different viewing angles with respect to each other. This makes it possible to provide a plurality of images 32 (321, 322 and 323) of the same part of the environment 26 from different perspectives, in which case this is illustrated by example by the images 321, 322 and 323 in FIG. 4. A model 30 of the part of the environment 26 can be created from the mages 32 which depict the same part of the environment 26 from different perspectives. An image of the part of the environment 26 can be extracted and/or rendered from the model 30 from that perspective which corresponds to the perspective of at least one of the cameras 16 and/or which corresponds to a perspective that lies between the perspectives of at least two of the cameras 16.

Provision may be made for an image of the model 30 of the part of the environment 26 from a first perspective to be displayed and/or imaged on the display apparatus 12. The perspective can be changed when the filter is applied. This means, in particular, that, as a result of the filter being applied, an image of the model 30 of the part of the environment 26, which shows the model 30 from a second perspective differing from the first perspective, is displayed on the display apparatus 12. The perspective can be modified continuously, wherein a speed and/or acceleration at which the perspective is modified depends on and/or correlates with the strength of the filter and/or the change factor.

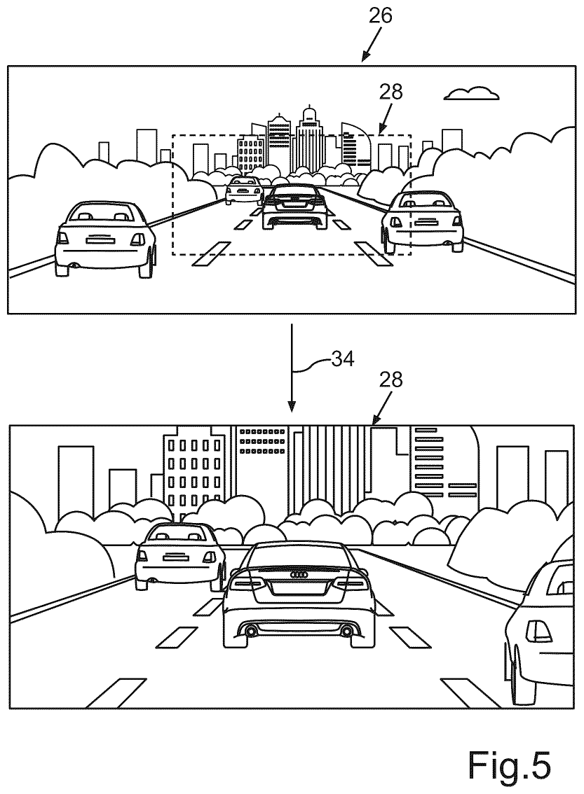

Additionally or alternatively, provision may be made for the filter to cause zooming 34 into the video, as illustrated by way of example in FIG. 5. This means that the environment 26 captured by the at least one camera 16 is zoomed into 34, with the result that, after zooming in 34, only an image section 28 of the environment 26, rather than the environment 26, is displayed and/or output on the display apparatus 12. This allows the image section 28 of the environment 26 to be displayed in enlarged form on the display apparatus 12. In an example, the environment 26 captured by a camera 16 whose capture area points in the direction of travel 18 of the motor vehicle 10 is zoomed into 34. Zooming in 34 may be carried out continuously, such that, when zooming in 34, an image section 28 of the environment 26 displayed on the display apparatus 12 means that an ever smaller part of the environment 26 can be displayed with an ever larger magnification. A speed and/or acceleration of the zooming in 34 can correlate with the strength of the filter and/or the change factor.

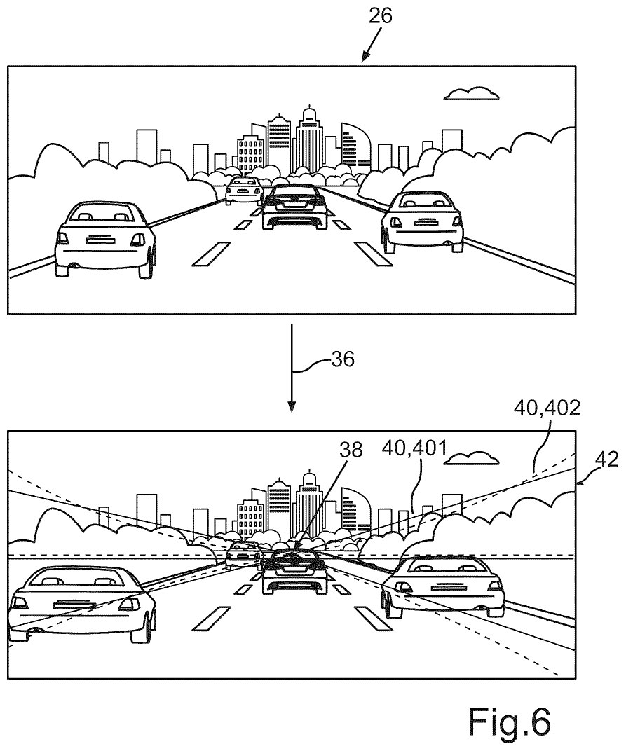

Additionally or alternatively, the filter may cause a distortion 36 of the video, as illustrated by way of example in FIG. 6. FIG. 6 shows an environment 26, as may be captured by at least one camera 16 which points in the direction of travel 18 of the motor vehicle 10. A distortion 36 of the environment 26 can be carried out by applying the filter, wherein the speed and/or acceleration at which the distortion 36 changes and/or the strength of the distortion 36 can correlate with the strength of the filter and/or with the change factor.

The distortion 36 may be carried out along lines 40 which extend from a center point 38 to an edge 42 of the video and/or of the environment 26. The center point 38 may be distinguished by the fact that this is centrally arranged on the display apparatus 12, and/or the center point 38 may be that point and/or that pixel which is centrally arranged on the display apparatus 12. The lines 40 can each start at the center point 38 and extend to the edge 42 of the video and/or of the environment 26 and/or of the display apparatus 12. The lines 40 can meet at the center point 38. In particular, the various lines 40 do not intersect and/or touch each other. Various lines can intersect and/or touch only at the center point 38. They may be straight lines 401 and/or curved lines 402. In FIG. 6, by way of example, straight lines 401 are drawn using continuous lines and curved lines 402 are drawn using dashed lines. In the example in FIG. 6, either the straight lines 401 or the curved lines 402 can be selected. The distortion 36 may involve pixels being stretched in that direction in which the respective line 40 running through the pixel points. The distortion 36 can increase, the further the respective pixel that is stretched is away from the center point 38 and/or the closer the respective pixel is to the edge 42.

Additionally or alternatively, an edited video, which is produced by applying the filter to the video and/or the video signals, can be displayed on the display apparatus 12 in the background, wherein an artificial horizon can be displayed in the foreground on the display apparatus 12. The artificial horizon may be a horizontal line and/or a line which is parallel to a top and/or bottom edge and/or delimitation of the display apparatus 12 in the vehicle vertical direction. In addition to the horizontal line, the artificial horizon may have a second line whose inclination relative to the horizontal line correlates with a lateral acceleration of the motor vehicle 10. In particular, the inclination of the second line relative to the horizontal line is greater, the greater the lateral acceleration determined. That part of the second line which is arranged on the outside of the bend may be arranged above the horizontal line during cornering; that part of the second line which is arranged on the inside of the bend may be arranged below the horizontal line during cornering.

In order to determine the lateral acceleration of the motor vehicle, the motor vehicle 10 may have at least one lateral acceleration sensor which for example captures an acceleration of the motor vehicle 10 perpendicular to the direction of travel 18 of the motor vehicle 10.

Additionally or alternatively, the video signals from the at least one camera 16 can be stored. The storage can take place in a memory 44 of the motor vehicle 10. The video signals, in particular after being stored in the memory 44 of the motor vehicle 10, can be played back at a slower speed on the display apparatus 12. Video signals may be available from that at least one camera 16 which also provides the video signals currently output on the display apparatus 12, wherein the available video signals have not yet been output on the display apparatus 12 and/or represent a time which is in the future starting from the video signals currently output on the display apparatus 12 and, in particular, is in the past starting from a current time. As a result of storage and playback at a slower speed, it is possible to provide video signals which are in the future starting from a current playback time which can describe the time at which the video signals were captured by the at least one camera 16.

If an acceleration which exceeds a predefinable acceleration threshold value is captured by the motor vehicle 10, in particular by the acceleration sensor 22, an accelerated playback of the video signals can take place. The transition to accelerated playback can be continuous. In particular, the playback speed of the video signals, in particular on the display apparatus, is continuously increased, for example, until the acceleration of the motor vehicle does not increase further. The accelerated playback may be a playback of the video signals at a speed which is greater than the slowed-down playback and/or corresponds to a recording speed at which the at least one camera 16 captures the video signals and/or is greater than the recording speed. For this purpose, it is possible to resort to the video signals stored in the memory 44 of the motor vehicle 10. This makes it possible to achieve a playback speed that is greater than the recording speed of the at least one camera 16.

In addition, an acceleration effect that can be caused by the application of the filter can be enhanced. The acceleration effect can result from the application of the filter and describes in particular the fact that a different, in particular a higher, speed and/or acceleration than the current speed and/or acceleration is perceived as the current speed and/or the current acceleration by an occupant of the motor vehicle 10.

The enhancement of the acceleration effect can be caused, for example, by simulating a simulation of at least one component of a way of transport at a way of transport acceleration and/or a way of transport speed on a simulation display apparatus in the motor vehicle, wherein the way of transport acceleration and/or the way of transport speed correlate(s) with the amplification factor. For example, at least one component part of an aircraft can be simulated, which is displayed on a second display apparatus, for example on at least one transparent display on at least one window of the motor vehicle 10 and/or on at least one display in the interior of the motor vehicle 10. The component part of the aircraft may be, for example, at least one landing flap and/or at least one wing and/or at least one engine of the aircraft. The component part of the aircraft may look different at different speeds and/or different accelerations. For example, landing flaps can be extended to different lengths and/or engines can be operated at different angular velocities of the rotor blades. In particular, in the case of a positive acceleration (the speed of the motor vehicle increases) of the motor vehicle 10, the at least one component part of the aircraft during a take-off of an aircraft is simulated and/or, if the motor vehicle 10 decelerates, the at least one component part of the aircraft during landing of the aircraft is simulated.

Additionally or alternatively, the enhancement of the acceleration effect can be caused by a runway and/or landing strip being displayed, in particular in a front area of the motor vehicle, for example on the second display apparatus.

Additionally or alternatively, sound effects, in particular a turbine sound, can be output in the motor vehicle, wherein the volume and/or pitch of said sound effects correlate(s) with the change factor. For example, a sound of an aircraft turbine can be output in the motor vehicle 10. In particular, the volume of the sound of the aircraft turbine may change with the acceleration and/or speed of the motor vehicle 10 and/or the volume of the sound of the aircraft turbine may correlate with the change factor. For example, the volume at which the sound of the aircraft turbine is output can be changed (increased and/or decreased) if the speed and/or acceleration of the motor vehicle change(s) (increase(s) and/or decrease(s)). In particular, in the case of a positive change in the speed and/or acceleration (the speed and/or acceleration increase(s)), a sound of an aircraft turbine during take-off of an aircraft may be output in the interior of the motor vehicle and/or outside the motor vehicle.

Additionally or alternatively, during cornering of the motor vehicle, a vehicle structure may be higher on the outside of a bend than on the inside of a bend by adjusting a suspension. This can be achieved, for example, by different spring travel on the inside of the bend and on the outside of the bend, for example in the case of an air suspension.

Additionally or alternatively, haptic feedback, in particular vibrations and/or movements of at least one vehicle seat, can correlate with the change factor. Thus, haptic elements, such as vehicle seats, which are located in the interior of the motor vehicle 10, can vibrate, wherein a strength of the vibration can depend on the amplification factor.

An example is described below.

The aim of the invention according to the examples is, in particular, to present an impression of a flight effect and/or a flight and/or a flight speed on a display apparatus, for example on at least one side window and/or on the windshield and/or on a screen, in particular a curved screen (curved monitor), in a motor vehicle.

At least one environmental sensor, in particular at least three environmental sensors, wherein the environmental sensor may be a camera which captures an environment around the motor vehicle, can be used to record images and/or to capture video data. The at least one environmental sensor may be fitted on one side and/or on the front of the motor vehicle in the direction of travel. The image recording and/or the video data can be enriched in particular with information from images and/or image data from at least one roof camera and/or a top-view camera (or a subsystem of a top-view camera) configured to present a top view of an environment around the motor vehicle. The image contents and/or image recording and/or video data of from the plurality of environmental sensors can be mixed, merged via an output channel and displayed on a display apparatus, for example on at least one side window and/or on a windshield and/or on a screen and/or on a curved screen in the motor vehicle and/or on a head-up display in the motor vehicle. In particular, the impression of the flight effect, in particular the impression of the flight effect during a take-off, can be produced.

The following steps can be carried out, in particular when starting a journey with the motor vehicle:

Video data can be captured by at least one environmental sensor, in particular by a plurality of environmental sensors which may be arranged next to each other and/or above each other and capture an environment around the motor vehicle from different viewing angles. The at least one environmental sensor, for example, all environmental sensors, is/are at least one camera which in particular captures an environment, that is to say an area outside the motor vehicle. The video data can be temporarily stored on a data carrier and/or a storage device in the motor vehicle.

As a result of the fact that, in the case of a plurality of environmental sensors, the environmental sensors are arranged in a manner offset from each other and/or, in the case of a plurality of environmental sensors, the environment is captured from the various viewing angles, an acceleration effect can arise when merging the video data from the individual environmental sensors to form a video, which effect may be similar to a tracking shot and/or a panning movement and/or may simulate a tracking shot and/or a panning movement of a camera. The acceleration effect can be produced, in particular, at the start and/or upon arrival of a journey with the motor vehicle. For this purpose, the production of the acceleration effect can be stored as a driving mode in the motor vehicle.

The video data and/or image signals from the plurality of environmental sensors can be combined and/or merged and/or superimposed to form a video and/or a widescreen video feed and/or a widescreen video stream.

In addition, the video and/or the widescreen video feed and/or the widescreen video stream can be enriched with information from the environment by using a roof camera and/or by using top-view camera images representing an environment of the motor vehicle as a top view of this environment and/or from a bird's eye view. This can be carried out in particular when merging and/or superimposing the video signals from the environmental sensors and/or the camera images from one side of a motor vehicle.

An acceleration effect, which simulates, for example, a tracking shot and/or a panning movement of a camera, can be produced by virtue of the fact that the image recordings and/or the video from the at least one environmental sensor, for example the plurality of environmental sensors, in particular the plurality of cameras, is/are played back and output in an accelerated manner. This makes it possible to produce and/or simulate a higher movement speed, in particular a movement speed which is higher than a current movement speed of the motor vehicle. This can produce a flight effect over a current environment.

The flight effect over the current environment can be produced in particular by combining the slightly offset camera recordings and/or video signals as well as by the accelerated playback of the image mixture and/or the video.

The video can be displayed on a display apparatus. The display apparatus can be, for example, at least one projector in the vehicle interior and/or a transparent display, in particular a transparent OLED (organic light emitting diode) display, on at least one side window and/or a display and/or a screen in a front area of the interior of the motor vehicle and/or an augmented reality projection, in particular on at least one side window and/or on a display and/or on a screen (for example via augmented reality glasses).

A flight impression can be created by combining real camera images, in particular based on the video signals, and/or the video and/or movement effects and/or faster image output and/or a display on the display apparatus.

Additionally or alternatively, an artificial horizon can be displayed on the display apparatus, for example on a curved screen and/or on a head-up display, which horizon pans to the right and/or to the left with a display and/or an edited video output on the display apparatus during cornering of the motor vehicle.

Additionally or alternatively, landing flaps, for example of an aircraft, can be displayed and/or simulated. Landing flaps can increase lift, for example of an aircraft. The landing flaps can be visually displayed on the display apparatus, for example on at least one window of the motor vehicle and/or on at least one display within the motor vehicle. The visual display of the landing flaps can make a flight behavior and/or a flight effect more realistic.

Additionally or alternatively, at least one landing strip and/or a runway, for example at a start of a journey and/or upon reaching a destination of the journey, can be displayed on at least one display apparatus and/or a part of the display apparatus, for example on a curved monitor and/or a head-up display.

Additionally or alternatively, a take-off and/or landing sound of an aircraft turbine and/or similar to an aircraft turbine can be output in the motor vehicle. The take-off and/or landing sound may correspond to a sound of an aircraft (jet) during take-off and/or landing.

Additionally or alternatively, the motor vehicle may comprise a lighting system which may correspond in terms of color and/or position to at least a landing light and/or a position light of an aircraft. Relative to the position may mean that the side on the aircraft corresponds to the side on the motor vehicle and/or that, along the direction of travel and/or flight, the relative position with respect to a center point (point that marks the spatial center of the vehicle and/or aircraft) and an edge point (point that marks an outer edge and/or an outer end of the vehicle and/or aircraft) of the motor vehicle and/or aircraft is the same. The lighting system can be activated when locking and/or unlocking the vehicle for a predefinable period of time, for example less than 1 minute, in particular less than 30 seconds.

Additionally or alternatively, at least one aircraft component, for example at least one wing and/or at least one landing flap and/or at least one engine, can be simulated and displayed on a display apparatus in the interior of the motor vehicle.

Additionally or alternatively, haptic feedback, in particular for a flight effect, for example a realistic flight effect and/or a realistic flight feeling, can take place. The haptic feedback may relate to at least one haptic element of the vehicle interior (interior of the motor vehicle), for example at least one seat of the motor vehicle, and/or vibrations and/or movements.

Additionally or alternatively, at least one camera may capture an underside of the motor vehicle, that is to say a lower outer side of the motor vehicle in the vehicle vertical direction, and/or a covering of the road on which the motor vehicle is driving, and/or a movement of at least one tire of the motor vehicle and may output and/or reproduce it/them on at least one display apparatus in the vehicle interior. For example, this can produce an effect of a fast flyover.

Additionally or alternatively, a sunrise and/or a sunset and/or a starry sky above the clouds can be displayed on at least one window of the motor vehicle, for example by means of a transparent display.

Overall, the examples show how a flight experience can be provided for a motor vehicle, in particular for the land jet, for example via a supersonic mode and/or a flight mode.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A method of processing for a motor vehicle, video signals generated by at least one camera of the motor vehicle to capture at least one part of an environment of the motor vehicle, comprising:
by at least one computer processor configured to execute a process to,
obtain acceleration signals from at least one acceleration sensor of the motor vehicle that describe a current acceleration of the motor vehicle
map the acceleration signals to a change factor, such that there is a positive or negative correlation between the acceleration signals and the change factor,
apply a parameterizable filter to the video signals, the parameterizable filter configured to cause a shift and/or selection of pixels from still images originating from a video obtained from the video signals, such that a strength of the parameterizable filter, which affects the shift and/or selection of the pixels, correlates with the change factor, and
edit the video signals with the parameterizable filter to output the video on at least one display apparatus of the motor vehicle.

2. The method according to claim 1, wherein the at least one computer processor is further configured to obtain speed signals from at least one speed sensor that describe a current speed of the motor vehicle, such that the speed signals are mapped to the change factor and, in a case of a positive correlation between the acceleration signals and the change factor, there is a positive correlation between the speed signals and the change factor and, in a case of a negative correlation between the acceleration signals and the change factor, there is also a negative correlation between the speed signals and the change factor, to affect the strength of the parameterizable filter.

3. The method according to claim 1, wherein the parameterizable filter causes a shift of an image section originated from the video signals, such that the image section as shifted is output on the at least one display apparatus, and the strength of the parameterizable filter affects a speed and/or acceleration of the shift of the image section.

4. The method according to claim 1, wherein the at least one computer processor is further configured to determine from the video signals from the at least one camera a model of the environment, which changes over time with the video signals, and simulates the environment mapped to the video signals from a plurality of perspectives, and
the parameterizable filter is configured to change a perspective from among the plurality of perspectives of the model,
wherein the strength of the parameterizable filter affects a speed and/or acceleration of a change of the perspective, such that the output of the video comprises rendering the environment from the model in the changed perspective.

5. The method according to claim 1, wherein the video signals describe the environment in a direction of travel of the motor vehicle and the parameterizable filter causes zooming into the video, wherein the strength of the parameterizable filter affects a speed and/or acceleration of the zooming into the video.

6. The method according to claim 5, wherein the parameterizable filter is further configured to cause a distortion of the video along lines which extend from a center point of the video, which is displayed and/or is arranged centrally on the at least one display apparatus, to an edge of the video, wherein the strength of the parameterizable filter affects a speed and/or acceleration at which the distortion is modified, and/or wherein the strength of the parameterizable filter indicates a strength of the distortion.

7. The method according to claim 6, wherein the edited video signals are output in a background of the video on the at least one display apparatus and an artificial horizon is simulated in a foreground of the video, an inclination of the artificial horizon correlates with a lateral acceleration indicated from the at least one acceleration sensor during cornering of the motor vehicle.

8. The method according to claim 1, wherein real-time processing of the video signals is carried out by the parameterizable filter.

9. The method according to claim 1, wherein an acceleration effect, which is caused by the parameterizable filter and simulates an acceleration which is higher than the current acceleration, is enhanced by at least one enhancement effect among enhancement effects including:
sound effects including a turbine sound, output in the motor vehicle, wherein a volume and/or a pitch of the sound effects correlate with the change factor,
a simulation of at least one component of a way of a transport is simulated at a way of transport acceleration and/or a way of transport speed on a simulation display apparatus among the at least one display apparatus in the motor vehicle, wherein the way of transport acceleration and/or the way of transport speed correlates with the change factor,
during cornering of the motor vehicle, a vehicle structure is higher on outside of a bend than on inside of a bend by adjusting a suspension of the motor vehicle, and/or
haptic feedback including vibrations and/or movements of at least one vehicle seat in the motor vehicle, correlates with the change factor.

10. The method according to claim 1, wherein the video signals are stored and are output at a slower speed on the at least one display apparatus and, at a current acceleration which exceeds a predefinable acceleration threshold value, an accelerated playback of the video signals takes place in addition to the parameterizable filter.

11. A motor vehicle comprising:
at least one display apparatus;
at least one camera configured to generate video signals to capture at least one part of an environment of the motor vehicle;
at least one acceleration sensor; and
at least one computer processor configured to execute a process to,
obtain acceleration signals from an acceleration sensor of the motor vehicle that describe a current acceleration of the motor vehicle
map the acceleration signals to a change factor, such that there is a positive or negative correlation between the acceleration signals and the change factor,
apply a parameterizable filter to the video signals, the parameterizable filter configured to cause a shift and/or selection of pixels from still images originating from a video obtained from the video signals, such that a strength of the parameterizable filter, which affects the shift and/or selection of the pixels, correlates with the change factor, and
edit the video signals with the parameterizable filter to output the video on at least one display apparatus of the motor vehicle.

12. The motor vehicle according to claim 11, wherein the at least one computer processor is further configured to obtain speed signals from at least one speed sensor that describe a current speed of the motor vehicle, such that the speed signals are mapped to the change factor and, in a case of a positive correlation between the acceleration signals and the change factor, there is a positive correlation between the speed signals and the change factor and, in a case of a negative correlation between the acceleration signals and the change factor, there is also a negative correlation between the speed signals and the change factor, to affect the strength of the parameterizable filter.

13. The motor vehicle according to claim 11, wherein the parameterizable filter causes a shift of an image section originated from the video signals, such that the image section as shifted is output on the at least one display apparatus, and the strength of the parameterizable filter affects a speed and/or acceleration of the shift of the image section.

14. The motor vehicle according to claim 11, wherein the at least one computer processor is further configured to determine from the video signals from the at least one camera a model of the environment, which changes over time with the video signals, and simulates the environment mapped to the video signals from a plurality of perspectives, and
the parameterizable filter is configured to change a perspective from among the plurality of perspectives of the model,
wherein the strength of the parameterizable filter affects a speed and/or acceleration of a change of the perspective, such that the output of the video comprises rendering the environment from the model in the changed perspective.

15. The motor vehicle according to claim 11, wherein the video signals describe the environment in a direction of travel of the motor vehicle and the parameterizable filter causes zooming into the video, wherein the strength of the parameterizable filter affects a speed and/or acceleration of the zooming into the video.

16. The motor vehicle according to claim 15, wherein the parameterizable filter is further configured to cause a distortion of the video along lines which extend from a center point of the video, which is displayed and/or is arranged centrally on the at least one display apparatus, to an edge of the video, wherein the strength of the parameterizable filter affects a speed and/or acceleration at which the distortion is modified, and/or wherein the strength of the parameterizable filter indicates a strength of the distortion.

17. The motor vehicle according to claim 16, wherein the edited video signals are output in a background of the video on the at least one display apparatus and an artificial horizon is simulated in a foreground of the video, an inclination of the artificial horizon correlates with a lateral acceleration indicated from the at least one acceleration sensor during cornering of the motor vehicle.

18. The motor vehicle according to claim 11, wherein real-time processing of the video signals is carried out by the parameterizable filter.

19. The motor vehicle according to claim 11, wherein an acceleration effect, which is caused by the parameterizable filter and simulates an acceleration which is higher than the current acceleration, is enhanced by at least one enhancement effect among enhancement 15 effects including:
sound effects including a turbine sound, output in the motor vehicle, wherein a volume and/or a pitch of the sound effects correlate with the change factor,
a simulation of at least one component of a way of a transport is simulated at a way of transport acceleration and/or a way of transport speed on a simulation display apparatus among the at least one display apparatus in the motor vehicle, wherein the way of transport acceleration and/or the way of transport speed correlates with the change factor,
during cornering of the motor vehicle, a vehicle structure is higher on outside of a bend than on inside of a bend by adjusting a suspension of the motor vehicle, and/or
haptic feedback including vibrations and/or movements of at least one vehicle seat in the motor vehicle, correlates with the change factor.

20. The motor vehicle according to claim 11, wherein the video signals are stored and are output at a slower speed on the at least one display apparatus and, at a current acceleration which exceeds a predefinable acceleration threshold value, an accelerated playback of the video signals takes place in addition to the parameterizable filter.
